(19) United States
(12) Patent Application Publication
(10) Pub. No.: US 2013/0172177 A1
(43) Pub. Date: Jul. 4, 2013

(54) SINTERING-STABLE HETEROGENEOUS CATALYSTS

(71) Applicants: Imme Domke, Jersey City, NJ (US); Wolfgang Rohde, Speyer (DE); Piotr Antoni Bazula, Traunstein (DE); Norbert Mronga, Dossenheim (DE); Yong Liu, Ludwigshafen (DE); Martin Dieterle, Ludwigshafen (DE); Stanley Roth, Yardley, PA (US); Curtis Zimmermann, Heidelberg (DE); Xinyi Wei, Princeton, NJ (US); Philipp Raff, Ludwigshafen (DE); Stephan Andreas Schunk, Heidelberg (DE); Olga Gerlach, Ludwigshafen (DE); Andreas Strasser, Neckarsteinach (DE); Michael Paul, Plankstadt (DE)

(72) Inventors: Imme Domke, Jersey City, NJ (US); Wolfgang Rohde, Speyer (DE); Piotr Antoni Bazula, Traunstein (DE); Norbert Mronga, Dossenheim (DE); Yong Liu, Ludwigshafen (DE); Martin Dieterle, Ludwigshafen (DE); Stanley Roth, Yardley, PA (US); Curtis Zimmermann, Heidelberg (DE); Xinyi Wei, Princeton, NJ (US); Philipp Raff, Ludwigshafen (DE); Stephan Andreas Schunk, Heidelberg (DE); Olga Gerlach, Ludwigshafen (DE); Andreas Strasser, Neckarsteinach (DE); Michael Paul, Plankstadt (DE)

(73) Assignee: BASF SE, Ludwigshafen (DE)

(21) Appl. No.: 13/824,113

(22) PCT Filed: Sep. 13, 2011
(86) PCT No.: PCT/IB2011/053990

§ 371 Date: Mar. 15, 2013

Related U.S. Application Data
(60) Provisional application No. 61/382,926, filed on Sep. 15, 2010.

(30) Foreign Application Priority Data
Sep. 15, 2010 (EP) 10176734.1

(51) Int. Cl. B01J 23/42

(52) U.S. Cl. CPC B01J 23/42
USPC 502/242; 502/240; 502/243; 502/250; 502/251; 502/252; 502/253; 502/262; 502/263

(57) ABSTRACT

A catalyst comprising (i) a support, (ii) metal particles and (iii) a shell which is arranged between the metal particles, wherein the shell (iii) comprises silicon oxide.

The invention relates to catalysts, preferably exhaust gas catalysts, in particular diesel oxidation catalysts and/or three-way catalysts, very particularly preferably diesel oxidation catalysts, comprising (i) a support, (ii) metal particles and (iii) a preferably porous shell which is arranged between the metal particles, wherein the shell (iii) comprises silicon oxide, preferably SiOₓ wherein x is equal to or less than 2, more preferably SiO₂, with the shell (iii) preferably being based on silicon oxide, preferably SiOₓ wherein x is equal to or less than 2, more preferably SiO₂, particularly preferably consisting of silicon oxide, preferably SiOₓ wherein x is equal to or less than 2, more preferably SiO₂. The invention further relates to processes for producing such catalysts.

Heterogeneous catalysts usually comprise a support component (or a plurality of support components) and an active component (or a plurality of active components). Thus, for example, a catalyst for automobile exhaust gas catalysis, e.g. a diesel oxidation catalyst (DOC), usually comprises a monolith which is coated with a washcoat. The washcoat comprises, for example, a porous γ-Al₂O₃ (e.g. the commercially available SBa series from Sasol) or porous silica alumina (e.g. the commercially available Siralox series from Sasol) which is impregnated with noble metal salts or precursors (e.g. Pd nitrates and Pt nitrates, H₂PtCl₆.6H₂O, or any other known noble metal salts or precursors); Pd and Pt catalyze the oxidation of CO to CO₂ or of hydrocarbons to CO₂. In the case of three-way catalysts, Rh is additionally applied as active metal component to reduce nitrogen oxides (2NO+2CO→N₂+2CO₂).

The noble metals are usually applied as salts (e.g. Pt nitrates or Pd nitrates or as tetrammineplatinum acetate solution or H₂PtCl₆ solution) to the Al₂O₃ by impregnation. The reduction of the noble metals, of Pd^{II}/Pt^{II} to Pd⁰/Pt⁰, may happen during the production process (e.g. chemically initiated by addition of, for example, glucose), during the heat treatment processes (e.g. in the flash calcination) or by means of thermal stress in the operating motor vehicle. After the reduction, the noble metal particles generally have a diameter in the range from 0.5 to 5 nm and can accordingly be referred to as nanoparticles. For the purposes of the present invention, the term “nanoparticles” refers to particles having an average diameter of from 1 to 500 nm, determined by electron microscopic methods.

The production and use of metallic nanoparticles is made difficult by their tendency to aggregate. During the production of metallic nanoparticles, the nanoparticles therefore have to be provided with electrostatic and/or steric stabilization or be embedded in suitable support systems. Known methods of stabilizing metallic nanoparticles utilize solid support materials such as silicon oxides, aluminum oxides or titanium oxides, molecular sieves or graphites on the generally large surface areas on which the metallic nanoparticles are formed or applied. In addition, polymers, dendrimers and ligands have also been used for stabilizing metallic nanoparticles and the stability of metallic nanoparticles in micelles, microemulsions, microspheres and other colloids has been studied.

When metal nanoparticles are used in automobile exhaust gas catalysts, there is the additional problem of high temperatures. The high temperatures of the engine, and thus also the high temperatures acting on the catalyst, greatly increase the mobility of the noble metal nanoparticles. It can be assumed that the mobility of the particles is drastically increased at ⅔ of the melting point of a metal. This effect can result in the noble metal nanoparticles sintering together, as a result of which the active surface area of the catalyst is significantly reduced. The lower the surface area of the active metal, the lower the catalytic activity. In the case of automobile exhaust gas catalysts (DOC, three-way catalysts (TWC), etc.), this effect plays a very important role since temperatures up to 900° C. (DOC) or 1100° C. (TWC) prevail here due to the vicinity to the engine and almost ⅔ of the melting point of the active metals can thus be reached (⅔ of the melting point of Pt is 1360.7° C.; ⅔ of the melting point of Pd is 1218.7° C. and ⅔ of the melting point of Rh is 1491.3° C.). The introduction of Pd into automobile catalysts has the significant advantage that the mobility of Pt can be reduced. Nevertheless, a significant decrease in activity of automobile exhaust gas catalysts can be observed.

Apart from this aggregation effect, some of the noble metals tend to migrate into the (oxidic) matrix, which likewise results in a loss of active metal (e.g. Rh⁽⁰⁾) and therefore a loss of active surface area. This effect has been described for Rh, in particular, and the formation of “rhodates” (Rh^{(III)} species) is known.

A possible way of reducing sintering and migration effects for active metals is to embed the active metal in a porous inorganic shell. Thus, WO 2007052627 A1 describes a catalyst which comprises not only the active component (the noble metals) but also a protective material which is intended to protect the particles from sintering together. Such protective materials are inorganic or organic barriers which are present between the particles.

It was therefore an objective of the invention to discover catalysts and processes for producing them which display a lower decrease in activity when exposed to high temperatures.

This objective has been achieved by the invention presented in the following.

The catalysts of the invention thus comprise a support and metal particles, with the metal particles being separated from one another by the shell. In a preferred embodiment, the shell (iii) can envelop the metal particles (ii). In this embodiment, the metal particle (ii) is usually not in direct contact with the support (i) but is joined to the support (i) via the shell (iii). This embodiment comes into consideration when, in particular, the metal particles (ii) are firstly enveloped by the shell (iii) and these enveloped metal particles (ii) are subsequently applied to the support (i). It is understood that the definition of “enveloped” here encompasses both a partial, or full, shell association with the metal particles.

In another preferred embodiment, the metal particles (ii) are arranged on the support (i) and in contact with the latter and the shell (iii) envelops the support (i) with the metallic particles (ii). This embodiment is obtained when the metal particles (ii) are firstly produced or fixed on the support (i) and the support (i) with the metal particles (ii) is subsequently enveloped by the shell (iii).

According to the invention, the shell (iii) is based on silicon oxide, preferably SiOₓ wherein x is equal to or less than 2, more preferably SiO₂. Compared to shells based on other oxides such as cerium oxide, zirconium oxide, aluminum oxide or other metal oxides, this offers the advantage that the synthesis of defined shells is significantly easier to control (Stöber method, controlled hydrolysis of water glass). This makes it possible to set the layer thickness of the silicon oxide, preferably SiOₓ wherein x is equal to or less than 2, more preferably SiO₂ shell precisely to 1-2 nm. Furthermore, the use of, in particular, water glass has significant economic advantages over metal-organic Zr, cerium or Al components, both in respect of the price of the starting materials and also in terms of avoiding working with organic solvents. In addition, silicon oxide has the advantage that such an inorganic silicon oxide layer having layer thicknesses of does not inhibit the catalytic activity.

Here, the shell (iii) can, according to the present invention, comprise from 0.1 to 20% by weight, based on the total weight of the shell (iii), of Zr, cerium, Ti, Al, Nb, La, In, Zn, Sn, Mg, Ca, Li, Na and/or K.

The shell (iii) preferably has a layer thickness in the range from 0.5 nm to 2000 nm, more preferably from 0.5 nm to 200 nm, particularly preferably from 0.5 nm to 50 nm, more particularly preferably from 0.5 nm to 10 nm, most preferably from 0.5 nm to 5 nm.

In addition, preference is given to catalysts which comprise, preferably in the shell (iii), from 0.1% by weight to 35% by weight, particularly preferably from 1% by weight to 20% by weight, most preferably from 5% by weight to 20% by weight of SiO₂, based on the total weight of support (i), metal particles (ii) and shell (iii).

The shell (iii) preferably comprises pores, preferably pores having a diameter in the range from 0.5 nm to 40 nm, particularly preferably from 1 nm to 20 nm. The pores are preferably configured in such a way that the metal particles (ii) are accessible to gases through the pores.

The catalysts of the invention comprise metal particles (ii) as active element. All metals which display catalytic activity in the elemental state are suitable. Preference is given to gold, silver, platinum, rhodium, palladium, copper, nickel, iron, ruthenium, osmium, chromium, vanadium, manganese, molybdenum, cobalt, zinc and mixtures and/or alloys thereof.

Preference is given to catalysts comprising Pt, Pd, Ru, Rh, Ir, Os, Au, Ag, Cu, Ni, Co and/or Fe, preferably Pt, Pd, Rh and/or Ru, particularly preferably Pt and/or Pd, as metal particles (ii).

The metal particles (ii) preferably have a diameter in the range from 0.1 nm to 200 nm, preferably from 0.5 nm to 200 nm, more preferably from 1 nm to 20 nm, particularly preferably from 1 nm to 10 nm.

In addition, preference is given to catalysts which comprise from 0.01 to 20% by weight, particularly preferably from 0.1 to 4% by weight, of metal particles, based on the total weight of support (i), metal particles (ii) and shell (iii).

The metal particles (ii) can either be crystalline or amorphous, which can be determined by means of high-resolution electron microscopy or X-ray diffraction. When more than one metal has been used, the metal particles (ii) can comprise alloys but it is also possible for monometallic nanoparticles of various metals to be present side by side.

As support (i), it is possible to use generally known supports which are, for example, commercially available under the trade names TM 100/150, SBa 150, Siralox 1.5, SBa 70 from Sasol. The support (i) is preferably based on at least one oxide of Al, Ce, Zr, Ti and/or Si, particularly preferably aluminum oxide, in particular alpha- or gamma-aluminum oxide.

The diameter of the primary particles of the support (i) is preferably in the range from 0.5 to 5000 nm, more preferably from 5 nm to 500 nm, particularly preferably from 5 to 300 nm, very particularly preferably from 10 to 50 nm. The primary particles can form agglomerates which can reach sizes of a number of microns.

The support (i) preferably has a BET surface area of greater than 5 m²/g, preferably in the range from 50 m²/g to 300 m²/g, more preferable from 75 m²/g to 150 m²/g, most preferable from 100 m²/g to 150 m²/g. Here, the BET surface area is determined by gas absorption in accordance with DIN ISO 9277. As a result of this high BET surface area, the nanosize noble metal particles in the pores are protected against aggregation but are at the same time accessible to reactive gases such as CO or other gases.

The invention further provides for the use of the products according to the invention as catalyst for chemical reactions. The chemical reaction is preferably a hydrogenation, dehydrogenation, hydration, dehydration, isomerization, nitrile hydrogenation, aromatization, decarboxylation, oxidation, epoxidation, amination, H₂O₂ synthesis, carbonate preparation, Cl₂ preparation by the Deacon process, hydrodesulfurization, hydrochlorination, metathesis, alkylation, acylation, ammoxidation, Fischer Tropsch synthesis, methanol reforming, exhaust gas catalysis (SCR), reduction, in particular of nitrogen oxides, carbonylation, C—C coupling reaction, C—O coupling reaction, C—B coupling reaction, C—N coupling reaction, hydroformylation or rearrangement.

The catalysts of the invention are suitable, in particular, for converting CO into CO₂ or oxidation of hydrocarbons to CO₂ and NO to NOₓ. However, the metal nanoparticles produced in this way can in principle also be used for other reactions which are known to be able to be catalyzed by the abovementioned metals, for example known hydrogenation or dehydrogenation reactions.

The catalysts can be used by combining the metal particles coated with the inorganic shell with a customary support material (SBa-150) and applying this washcoat to a shaped body in a further step. This monolithic shaped body can comprise, for example, cordierite or metal. Here, the formulations of the individual washcoat components and the shape and material of the support can be matched in a customary way to the purpose for which the catalyst is used.

The production of the catalysts of the invention can comprise the following steps:
dissolution of a metal precursor in a solvent in the presence of a stabilizer or only addition of a stabilizer to an existing metal salt solution,
reduction of the metal precursor and formation of nanoparticles,
optionally replacement of the solvent,
forming of an inorganic shell,
addition of a support,
optionally application of the catalytically active dispersion prepared in this way to a further shaped body (monolith),
heat treatment or optionally calcination.

The present invention further provides processes for producing a catalyst comprising (i) a support, (ii) metal particles and (iii) a preferably porous shell based on silicon oxide, preferably SiOₓ wherein x is equal to or less than 2, more preferably SiO₂ which is preferably arranged between the metal particles, wherein
(a) the metal particles are produced by reduction of an optionally stabilized metal salt solution, subsequently
(b) the shell (iii) which encloses the metal particles (ii) is produced by reaction of water-soluble, hydrolyzable Si compounds, preferably water glass (M₂SiO₃.xH₂O where M=Li, Na, Cs and/or K and x=4, 5 or 6), tetraethyl orthosilicate and/or tetramethyl orthosilicate, particularly preferably tetraethyl orthosilicate and/or tetramethyl orthosilicate, and optionally small amounts of a metal-organic cerium, Al, Zn, Zr, La, In, Ti or Ir compound preferably at an alkaline pH in the range from 9 to 10.5 or an acidic pH in the range from 2 to 2.5 in the presence of the metal particles (ii), then optionally
(c) the metal particles (ii) enveloped by silicon oxide, preferably SiOₓ wherein x is equal to or less than 2, more preferably SiO₂ are separated off from the solvent and dried, preferably until the water content is less than 25% by weight, based on the total weight, then optionally
(d) the dried metal particles (ii) which are enclosed by the shell (iii) are dispersed in a solvent, preferably water, with the dispersion preferably having a solids content in the range from 1 to 20% by weight, based on the total weight of the dispersion, subsequently
(e) a support (i) is added to the dispersion, then optionally
(f) the solvent is removed from the dispersion, preferably producing the catalyst, comprising (i) the support, (ii) metal particles and (iii) the shell, the preferably supported (ii) metal particles preferably encapsulated by (iii) the shell, and the catalyst obtained in this way is preferably subsequently
(g) calcined, preferably at temperatures in the range from 100° C. to 950° C., preferably for a time in the range from 5 to 300 minutes, preferably at a heating rate in the range from 0.5 to 10 K/min, preferably from 0.5 K/min to 2 K/min.

Here, the expressions “then” and “subsequently” mean that the next process step in each case is carried out later than the previous step. It can directly follow the previously described process step, but process steps which are not essential to the invention, e.g. change of the solvent or the like, can be inserted in between. “Enclosed” means that the shell has pores which make the metal particles (ii) accessible to gases.

Individual steps are described in detail below.

### Step (a)

To produce the metal salt solution, it is usual to stir a metal salt, hereinafter also referred to as precursor, preferably together with a customary stabilizer, e.g. a polymer known for this purpose, in a suitable solvent, for example in water. Suitable precursors are the nitrates, acetylacetonates, acetates, amines, hydroxides, acids, sulfates, sulfides, cyanides, isocyanates, thioisocyanates, halides, hypochlorites, phosphates, tetrammine complexes, oxides or other soluble compounds of the corresponding metal, for example the elements mentioned at the outset for the metal particles (ii), preferably Pt, Pd, Rh and/or Ru, particularly preferably Pt and/or Pd. Preference is given to using the corresponding metal nitrates or the tetrammine complexes, in particular nitrates or the tetrammine complexes of Pt, Pd, Rh and/or Ru, particularly preferably Pt and/or Pd. Very particular preference is given to starting out from metal salt components which are already present in solution, but is not limited to a solution of the metal precursor. Suitable solvents are water and polar organic solvents such as alcohols. The solvent is preferably matched to the precursor since the precursor has to be dissolved in the solvent used. Preference is given to using water as solvent. Suitable stabilizers are polymers which have one or more functional groups which can coordinate to the metal. Functional groups are, for example, carboxylates, carboxylic acid, gluconic acid, amines, imines, pyrroles, pyrrolidones, pyrrolidines, imidazoles, caprolactams, esters, urethanes and derivatives thereof. Suitable polymers are accordingly polyethyleneimines, polyvinylamines, as described, for example, in WO 2009/115506. Particular preference is given to using the PVP K 30 in this method of synthesis. The concentration of the stabilizer can be in the range from 0.1 to 50% by weight, preferably from 1 to 10% by weight, based on the weight of the active metal components. A reducing agent is then added to the aqueous mixture comprising metal salt and stabilizer.

The reduction to the metal can be carried out using any reducing agent which is able to convert the metal ions and/or complexes into the elemental form. Suitable reducing agents are alcohols, ketones, carboxylic acids, hydrazines, azo compounds (e.g. AIBN), carboxylic anhydrides, alkenes, dienes, monosaccharides or polysaccharides, hydrogen, borohydrides or other reducing agents known to those skilled in the art. Preference is given to using water-soluble reducing agents from which gaseous compounds (e.g. N₂, CO₂) are formed. Preference is given to using hydrazine, alcohols, aldehydes, for example formaldehyde, glycols or carboxylic acids, for example citric acid. The pH is optionally adjusted, with particular preference being given to an alkaline pH.

### Step (b)

The metal particles (ii) are coated with an inorganic shell based on SiOₓ (x is equal to or less than 2). This step is preferably carried out in an alcoholic medium, i.e. if water has been used as solvent in the first step (a), the metal particles (ii) are preferably separated off, for example by means of a centrifuge, and dispersed in an alcoholic solvent. Ethanol is preferred as alcoholic solvent. Coating of the particles is then carried out, preferably in a generally known Stöber process, in which the, for example, ethanolic solution is treated with aqueous ammonia and tetraethyl orthosilicate is added.

### Step (d)

The concentration of support material depends on the application. It is usual to add such an amount of support material that a metal loading in the range from 1 to 4% by weight is obtained after calcination. The support can be dispersed by means of an Ultraturrax, a Turrax, an ultrasonic bath or another stirring device known to those skilled in the art. Preference is given to an Ultraturrax. The slurry obtained can be used directly for coating monoliths, with the slurry usually being additionally milled and brought to a usually acidic pH before being combined with the monolith. In the examples presented, the suspension was dried, calcined, tableted and used in this form for powder measurements for the reaction of CO to form CO₂.

As an alternative, the production of the catalysts of the invention can also be carried out by firstly applying the metal particles (ii) to the support (i) and only then enveloping the support (i) together with metal particles (ii) with the shell (iii) based on SiOₓ (x is equal to or less than 2).

This production process can comprise the following steps:
impregnation of a support with metal precursors,
optionally calcination of the support with metal precursors in air or nitrogen,
optionally dispersion of the support preferably with metal precursors in a solvent and reduction of the metal salt component to the metal,
dispersion of the support prepared in this way in a solvent,
the setting of the reaction conditions (temperature, pH, reaction time) for forming the shell,
addition of the precursor for the shell material,
optionally application of the resulting dispersion to a shaped body (monolith), calcination.

The individual steps are described in detail below:

The support can firstly be impregnated with an active metal precursor. This impregnation step is carried out by methods known to those skilled in the art. The compounds described above in this text in the above-described solvents are suitable as active metal precursor.

Optionally, the support impregnated with the metal precursor can be calcined in air or nitrogen to form metal particles with diameters in the range from 0.1 nm to 200 nm, preferably from 0.5 nm to 20 nm, particularly preferably from 0.5 nm to 10 nm. The calcination temperature is preferably in the range from 100 to 700° C., more preferably from 300 to 650° C., particularly preferably from 400° C. to 550° C.

The support impregnated with active metal precursor can subsequently be dispersed in a dispersion medium. The active metal component can be present here either as salt or as previously formed metal particles. The solvent is preferably water or a polar organic solvent, preferably one having a dielectric constant ∈≧10 C²/J·m, particularly preferably methanol, ethanol or glycols. A very particularly preferred dispersion medium for the support material is water. The solids content can be in the range from 0.1 to 20% by weight of support, based on the dispersion medium, with solids contents in the range from 0.5 to 10% by weight being preferred for this method of production. When dispersing the support in the dispersion medium, it is preferably ensured that the support particles are well separated from one another and do not settle. This ensures good accessibility of the shell material for the entire support surface. The support can be dispersed in the dispersion medium either by means of an Ultraturrax, a Turrax, an ultrasonic bath or other stirring devices or another apparatus known to those skilled in the art which introduces sufficient shear energy into the system for the support particles to be dispersed homogeneously in the dispersion medium.

The reaction conditions for producing the shell (iii) are then usually set. For this purpose, the dispersion composed of support and dispersion medium is preferably heated to a temperature in the range from 60 to 95° C., particularly preferably 80° C., and brought to a pH in the range from 7 to 11. Particular preference is given to a pH of 7 to 10, more preferably to a pH of 8 to 10 (measured at 80° C. without temperature correction). The pH is preferably adjusted using dilute sodium hydroxide solution.

In the next step, the precursor of the shell material for coating the support already comprising the noble metal can be added. Unlike the first method described (in which only the active component is surrounded by a shell material), the total support is enveloped in this method. Preference is given to using water-soluble hydrolyzable Si compounds, for example tetramethyl orthosilicates (TMOS), tetraethyl orthosilicates (TEOS) and/or water glasses (M₂SiO₃.xH₂O where M=Li, Na, Cs and/or K and x=4, 5 or 6) as precursor, with particular preference being given to using the inexpensive water glasses. The precursor is preferably added at a constant rate over a number of hours. During the addition of Si compounds, the pH of the system is preferably kept in the range from 7 to 11, more preferably from 7.5 to 9.5, particularly preferably from 8 to 10. The concentration of the shell materials depends on the catalyst to be coated and can vary in the range from 0.1 to 80% by weight. When automobile catalysts are used by way of example, concentrations in the range from 1 to 40%, preferably 5 to 30% by weight of shell material, based on the support plus active metal, are preferred. Electrolytes such as NaNO₃ can optionally be added. The reaction mixture is subsequently preferably stirred well. Customary reaction times for forming a SiOₓ (x is equal to or less than 2) shell around the heterogeneous catalyst are between 1 and 10 hours when using water glass. After the reaction time has elapsed, excess salt ballast can be removed by washing, preferably with water, and dried, for example by means of filtration through a “blue band” filter, preferably having a layer thickness of <1 mm. The catalyst is then preferably dried, preferably in a convection drying oven at 60° C., until the water content is less than 20%.

The dispersion can subsequently be applied to, for example, a monolith. The application of a catalyst to a monolith and the subsequent calcination are generally known and disclosed in many documents. Possible monoliths are, for example, materials composed of metal/cordierite. Corresponding shaped bodies are, for example, obtainable from Corning and NGK. The porosity of the catalyst can be set via the calcination profile and the way in which the reaction is carried out and be matched to the respective application (TWC, DOC). The catalyst can thus be process further to produce a washcoat slurry as coating component for monoliths, optionally after brief milling and setting of an acidic pH (pH about 3). The previously heat-treated powder is optionally calcined before production of the washcoat, usually at heating rates of 0.5-2 K/min to a temperature of 540° C., heating at 540° C. for 2 hours and subsequent cooling. However, in the examples presented, the sample was immediately dried and calcined and the catalytic activity for the oxidation of CO, HC and NO was examined.

The present invention therefore also provides a process for producing the catalysts of the invention comprising (i) a support, (ii) metal particles and (iii) a preferably porous shell based on silicon oxide, preferably SiOₓ wherein x is equal to or less than 2, more preferably SiO₂ which is preferably arranged between the metal particles, wherein
(h) a support (i) comprising metal particles (ii) is dispersed, subsequently
(i) water-soluble, hydrolyzable Si compounds, preferably tetramethyl orthosilicate, tetraethyl orthosilicate and/or water glasses (M₂SiO₃.xH₂O where M=Li, Na, Cs and/or K and x=4, 5 or 6), are added, preferably at a temperature in the range from 60° C. to 95° C. and preferably at a pH in the range from 7 to 10, more preferably from 8 to 10, subsequently
(j) the catalysts comprising (i) the support, (ii) metal particles and (iii) the shell are dried, particularly preferably until the water content is less than 25% by weight, based on the total weight, particularly preferably after the catalyst has been filtered off, preferably filtered off by means of a broadband filter, and the catalyst obtained in this way is preferably subsequently
(k) calcined, preferably at temperatures in the range from 100° C. to 950° C., preferably for a time in the range from 5 to 300 minutes, preferably at a heating rate in the range from 0.5 to 10 K/min, more preferably from 0.5 to 8 K/min.

### EXAMPLES

The production of powder samples having an inorganic protective shell around the active metal is described in the following. The improved stability at high temperatures is examined for the example of diesel oxidation catalysis, with the support materials, precursors and loading of active metal having been selected so that the catalysts serve as model catalysts for diesel oxidation catalysis. The oxidation reaction of CO to form CO₂ was selected as model reaction. The feed gas composition simulating Diesel exhaust was applied in the catalytic measurements. The light off (L/O) temperatures (the temperature at which 50% of the CO has been converted in CO₂) were determined on fresh and hydrothermally aged catalysts. The L/O temperature on aged catalyst is a measure of the long-term stability of an automotive catalyst.

### Synthesis Examples

### Example 1

### Direct Coating of the Active Metal Component with SiOₓ (x is Equal to or Less than 2)

0.96 g of Pt(NO₃)₂ was dissolved in 30 ml of water and 2.56 g of polyvinylpyrrolidone K 30 (from Fluka, CAS 9003-99-8, mass ratio of Pt precursor to PVP: 0.375) was added as stabilizer. The mixture is stirred until a clear solution has been formed. 1.9 g of a 36.5% strength formaldehyde solution (from Sigma-Aldrich, CAS 50-00-0) and 0.6 g of a 30% strength NaOH solution (from Riedel de Haen, CAS 1310-73-2) were subsequently added as reducing agent. The mixture was stirred for 10 minutes and the solution which was now anthracite-colored as a result of the reduction was subsequently centrifuged in a laboratory centrifuge (Hettich Universal 2s) for 10 minutes (3000 rpm). The supernatant solution was decanted off and the gel-like residue was redispersed in 70 ml of ethanol. 3.5 ml of 25% strength aqueous ammonia were added and the dispersion was treated with ultrasound for 30 minutes. 5.5 ml of tetraethyl orthosilicate were then added and the system was stirred at 23° C. (room temperature) for 24 hours, resulting in formation of the precursor of the inorganic SiOₓ (x is equal to or less than 2) shell (in the form of crosslinked Si—O oligomers). 25 g of SBa-150 (γ-Al₂O₃ from Sasol) were then added as support for the active metal component and the mixture was homogenized by means of an Ultraturrax for 5 minutes. The mixture was stirred for another 1 hour. The volatile constituents are removed under reduced pressure and the powder is calcined (heating rate 0.5° C./min up to a temperature of 350° C.; subsequently 5 minutes at 350° C.; subsequently heating rate of 2° C./min up to a temperature of 540° C.; subsequently 1 hour at 540° C.; 50 standard liters per hour of nitrogen). This gave 22.2 g of a core-shell catalyst comprising 1.4% by weight of Pt. Transmission electron microscopic (TEM) analysis confirmed nanosize Pt particles surrounded by SiOₓ (x is equal to or less than 2) shells, layer thickness in the range from 2 to 27 nm. Well-separated Pt particles which have a primary particle size of 1-2 nm and are enclosed in a common shell can be identified.

### Example 2

### Direct Coating of the Active Metal Component with SiOₓ (x is Equal to or Less than 2)

The experiment was carried out in a manner analogous to example 1 using a ratio of Pt precursor to PVP of 0.6. Clearly separated particles which have a diameter of 1-7 nm and are surrounded by a 10 nm thick SiOₓ (x is equal to or less than 2) shell can be seen. Even when the sample which has been coated in this way is heated at 750° C. for 6 hours, the Pt particles grow only slightly (from 1-7 nm to 8-22 nm).

### Example 3

### Direct Coating of the Active Metal Component with SiOₓ (x is Equal to or Less than 2)

The procedure of example 1 was repeated, but all starting quantities were doubled, with the exception of the support of which 8 g were used. Calcination gave 7.1 g of a core-shell catalyst comprising 2.2% by weight of Pt.

### Example 4

### Coating of the Entire Support and Active Metal with SiOₓ (x is Equal to or Less than 2)

To produce Al₂O₃ support impregnated with platinum, 0.96 g of Pt(NO₃)₂ was dissolved in 30 ml of water and 2.56 g of polyvinylpyrrolidone K 30 (from Fluka, CAS 9003-99-8, mass ratio of Pt precursor to PVP=0.375) were added as stabilizer. The mixture was stirred until a clear solution had been formed. SBa-150 (as 30% strength by weight dispersion in 50:50 water-diethylene glycol) was subsequently added in such an amount that, after complete loading of the SBa-150 with the Pt present in solution, the Pt loading on the support was 2%. The dispersion was subsequently heated at 100° C. for 1 hour, as a result of which the Pt^{(II)} was reduced to Pt⁽⁰⁾. The successful reduction was recognized by the characteristic color change from light yellow (Pt^{(II)}) to brown (Pt⁽⁰⁾). After the reaction was complete, the mixture was filtered, the solid was predried at RT under reduced pressure for 24 hours and subsequently calcined (heating rate 0.5° C./min to a temperature of 350° C.; subsequently 5 minutes at 350° C.; subsequently heating rate of 2° C./min up to a temperature of 540° C.; subsequently 1 hour at 540° C.; 50 standard liters per hour of nitrogen). 5 g of these nanoparticles impregnated with 2% by weight of Pt (primary particle size of the Pt nanoparticles: 1-3 nm*) were introduced into 995 g of deionized water in a stirred 2 l four-neck flask provided with a glass-Teflon stirrer. The mixture was heated to 80° C. while stirring (300 rpm). 25 g of a commercially available water glass solution having a solids content of about 28%, a density (at 20° C.) of 1.25 g/cm³ and a pH of 10.8 were added over a period of 4 hours. At the same time, the pH was kept constant in the range 7.5-9.5 by means of 5% strength nitric acid, with the temperature being kept constant at 80° C. The mixture was stirred for a further 30 minutes. The suspension was subsequently filtered with suction, washed free of salts and dried at 60° C. in a convection drying oven. This gave a SiOₓ (x is equal to or less than 2)-coated catalyst having a 0.5-1 nm thick SiOₓ (x is equal to or less than 2) layer.

### Example 5

### Coating of the Entire Support and Active Metal with SiOₓ (x is Equal to or Less than 2)

To produce nanoparticles impregnated with platinum, 4.03 g of Pt acetylacetonate (Pt(AcAc)₂, from ABCR) was added to 29.72 g of diethylene glycol (DEG) and stirred with magnetic stirring overnight to form a yellow suspension. 100 g of SBa 150 support was added to a 1 L flask and N₂ is purged through overnight at a flow of 100 L/h (N₂ is used in the whole process until drying). 150.3 g of DEG was then added and the mixture was heated up to 30° C. under mechanic stir-ring (300 r/min). 0.217 g of PVP K30 was added and the temperature of the mixture was further increased to 80° C. After the temperature of SBa-150/DEG/PVP mixture reached 80° C., the Pt(AcAc)₂/DEG suspension was slowly added through a glass funnel (21.4 g of DEG was used to wash the Pt(AcAc)₂/DEG suspension beaker). The mixture was stirred at 80° C. for another 2 hours under N₂ and then dried under reduced pressure at 125° C. for 24 hours. Thus dried catalyst was then calcined in a rotary kiln at 540° C. (0.5° C./min to 350° C. then 2° C./min to 540° C.) in air (20 L/h) with a rotating rate of 7 min⁻¹. The Pt loading of thus prepared catalyst is 2 wt %, as is confirmed by elemental analysis. High resolution transmission electron microscopy (HRTEM) was then used to characterize thus prepared catalyst. It can be seen that the catalyst comprised of Al₂O₃ support and Pt nanoparticles. The primary particle size of the Al₂O₃ support was determined to be between 5 and 75 nm, and the size of Pt nanoparticles was between 3 and 10 nm. The BET surface area of thus prepared catalyst was determined to be 130 m²/g using nitrogen adsorption measurement.

In order to prepare the shell material, 15 g of Pt/Al₂O₃ catalyst and 2985 g of de-ionized water were added to a flask which was placed in super sonic bath and then heated up to 80° C. under super sonic and mechanical stirring. The pH value of the suspension was adjusted to 8.8 using 5 wt % NaOH solution (pH measured at 80° C.). 5 wt % water glass solution was then slowly added to the suspension to result in a SiO₂ loading of 10 wt % (based on the total weight of support, active metal and shell). During the process, 5 wt % of HNO₃ solution was used to keep the pH value constant at 8.8. After the desired amount of K₂SiO₃ was added, the suspension was stirred for another 30 min at 80° C. and then cooled down to room temperature. The product was finally filtrated, carefully washed with de-ionized water, and dried at 60° C. HRTEM characterization of the 10 wt % SiOₓ (x is equal to or less than 2) coated Pt/SBa catalyst indicated that the size distribution of Pt nanoparticles remained the same compared to the uncoated catalyst, and the thickness of SiOₓ (x is equal to or less than 2) shell is between 0.5 and 5 nm. Furthermore, thus prepared 10 wt % SiOₓ (x is equal to or less than 2) coated Pt/SBa catalyst has a BET surface area of 123 m²/g.

### Example 6

### Coating of the Entire Support and Active Metal with SiOₓ (x is Equal to or Less than 2)

The experiment was carried out in a manner analogous to example 5, the only difference being that the amount of water glass solution in the synthesis of SiOₓ (x is equal to or less than 2) shell was increased to result in a SiO₂ loading of 20 wt % (based on the total weight of support, active metal and shell). HRTEM characterization of the 20 wt % SiOₓ (x is equal to or less than 2) coated Pt/SBa catalyst indicated that the size distribution of Pt nanoparticles remained the same at 3 to 10 nm. The thickness of SiOₓ (x is equal to or less than 2) shell was determined to be between 0.5 to 5 nm. The BET surface area of thus prepared 20 wt % SiOₓ (x is equal to or less than 2) coated Pt/SBa catalyst was measured to be 110 m²/g.

### Example 7

### Coating of the Entire Support and Active Metal with SiOₓ (x is Equal to or Less than 2)

The experiment was carried out in a manner analogous to example 5, the only difference being that the amount of water glass solution in the synthesis of SiOₓ (x is equal to or less than 2) shell was increased to result in a SiO₂ loading of 30 wt % (based on the total weight of support, active metal and shell). HRTEM characterization of the 30 wt % SiOₓ (x is equal to or less than 2) coated Pt/SBa catalyst indicated that the size distribution of Pt nanoparticles remained the same at 3 to 10 nm. The thickness of SiOₓ (x is equal to or less than 2) shell was determined to be between 0.5 to 10 nm. The BET surface area of thus prepared 30 wt % SiOₓ (x is equal to or less than 2) coated Pt/SBa catalyst was measured to be 90 m²/g.

### Example 8

### Coating of the Entire Support and Active Metal with SiOₓ (x is Equal to or Less than 2)

The experiment was carried out in a manner analogous to example 5, the only difference being that the amount of water glass solution in the synthesis of SiOₓ (x is equal to or less than 2) shell was increased to result in a SiO₂ loading of 60 wt % (based on the total weight of support, active metal and shell). HRTEM characterization of the 60 wt % SiOₓ (x is equal to or less than 2) coated Pt/SBa catalyst indicated that the size distribution of Pt nanoparticles remained the same at 3 to 10 nm. The thickness of SiOₓ (x is equal to or less than 2) shell was determined to be between 0.5 to 15 nm. In certain part of the sample, separate SiOₓ (x is equal to or less than 2) particles with size up to 100 nm can be observed. The BET surface area of thus prepared 60 wt % SiOₓ (x is equal to or less than 2) coated Pt/SBa catalyst was measured to be 50 m²/g.

### Example 9

### Coating of the Entire Support and Active Metal with SiOₓ (x is Equal to or Less than 2)

To produce nanoparticles impregnated with platinum, 5.102 kg of SBa-150 was weighted and placed into a mixer bowl. 321 g of H₂PtCl₆.6H₂O was diluted to the incipient wetness impregnation volume of the support and added dropwise to the SBa-150 support under mixing. After the addition of H₂PtCl₆.6H₂O, the impregnated powder was mixed for another 5 min and then sealed in a container for 2 hours so that the liquid was soaked. Afterwards, the sample was first dried at 110° C. for 4 hours and then calcined at 450° C. in air (ramp within 1 h) in a muffle oven. The Pt loading of thus prepared catalyst was 3 wt %, as was confirmed by elemental analysis. HRTEM measurement indicated that the primary particle size of the Al₂O₃ support was between 5 and 75 nm, and the size of Pt nanoparticles was between 1 and 6 nm. The synthesis of SiOₓ (x is equal to or less than 2) shell was analogous to example 5, the only difference being that water glass solution was added in such an amount that a SiO₂ loading of 15 wt % (based on the total weight of support, active metal and shell) was obtained. HRTEM characterization of the wt % SiOₓ (x is equal to or less than 2) coated Pt/SBa catalyst indicated that the size distribution of Pt nanoparticles remained the same at 1 to 6 nm. The thickness of SiOₓ (x is equal to or less than 2) shell was determined to be between 0.5 to 5 nm. The BET surface area of thus prepared 15 wt % SiOₓ (x is equal to or less than 2) coated Pt/SBa catalyst was measured to be 122 m²/g.

### Example 10

### Coating of the Entire Support and Active Metal with SiOₓ (x is Equal to or Less than 2)

The experiment was carried out in a manner analogous to example 9, the only difference being that in the synthesis of SiOₓ (x is equal to or less than 2) shell, water glass solution was added in such an amount that a SiO₂ loading of 20 wt % (based on the total weight of support, active metal and shell) was obtained. HRTEM characterization of the 20 wt % SiOₓ (x is equal to or less than 2) coated Pt/SBa catalyst indicated that the size distribution of Pt nanoparticles remained the same at 1 to 6 nm. The thickness of SiOₓ (x is equal to or less than 2) shell was determined to be between 0.5 to 5 nm. The BET surface area of thus prepared 20 wt % SiOₓ (x is equal to or less than 2) coated Pt/SBa catalyst was measured to be 120 m²/g.

### Example 11

### Coating of the Entire Support and Active Metal with SiOₓ (x is Equal to or Less than 2)

The experiment was carried out in a manner analogous to example 9, the only difference being that in the synthesis of SiOₓ (x is equal to or less than 2) shell, water glass solution was added in such an amount that a SiO₂ loading of 25 wt % (based on the total weight of support, active metal and shell) was obtained. HRTEM characterization of the 25 wt % SiOₓ (x is equal to or less than 2) coated Pt/SBa catalyst indicated that the size distribution of Pt nanoparticles remained the same at 1 to 6 nm. The thickness of SiOₓ (x is equal to or less than 2) shell was determined to be between 0.5 to 8 nm. The BET surface area of thus prepared 25 wt % SiOₓ (x is equal to or less than 2) coated Pt/SBa catalyst was measured to be 101 m²/g.

### Example 12

### Coating of the Entire Support and Active Metal with SiOₓ (x is Equal to or Less than 2)

The experiment was carried out in a manner analogous to example 9, the first difference being that another support, Siralox 1.5 (commercial product from Sasol) was used instead of SBa 150. The Pt content was the same (3 wt %) compared to example 9. HRTEM measurement indicated that the primary particle size of the support was between 5 and 50 nm, and the size of Pt nanoparticles was between 1 and 6 nm. The BET surface area of thus prepared catalyst was measured to be 94 m²/g. The second difference compared to example 9 is that in the synthesis of SiOₓ (x is equal to or less than 2) shell, water glass solution was added in such an amount that a SiOₓ (x is equal to or less than 2) loading of 5 wt % (based on the total weight of support, active metal and SiOₓ (x is equal to or less than 2) shell) was obtained. HRTEM characterization of the 5 wt % SiOₓ (x is equal to or less than 2) coated Pt/Siralox catalyst indicated that the size distribution of Pt nanoparticles remained the same at 1 to 6 nm. The thickness of SiOₓ (x is equal to or less than 2) shell was determined to be between 0.5 to 2 nm. The BET surface area of thus prepared 5 wt % SiOₓ (x is equal to or less than 2) coated Pt/Siralox catalyst was measured to be 94 m²/g.

### Example 13

### Coating of the Entire Support and Active Metal with SiOₓ (x is Equal to or Less than 2)

The experiment was carried out in a manner analogous to example 12, the only difference being that in the synthesis of SiOₓ (x is equal to or less than 2) shell, water glass solution was added in such an amount that a SiO₂ loading of 10 wt % (based on the total weight of support, active metal and shell) was obtained. HRTEM characterization of the 10 wt % SiOₓ (x is equal to or less than 2) coated Pt/Siralox catalyst indicated that the size distribution of Pt nanoparticles remained the same at 1 to 6 nm. The thickness of SiOₓ (x is equal to or less than 2) shell was determined to be between 0.5 to 3 nm. The BET surface area of thus prepared 10 wt % SiOₓ (x is equal to or less than 2) coated Pt/Siralox catalyst was measured to be 90 m²/g.

### Example 14

### Coating of the Entire Support and Active Metal with SiOₓ (x is Equal to or Less than 2)

The experiment was carried out in a manner analogous to example 12, the only difference being that in the synthesis of SiOₓ (x is equal to or less than 2) shell, water glass solution was added in such an amount that a SiO₂ loading of 20 wt % (based on the total weight of support, active metal and shell) was obtained. HRTEM characterization of the 20 wt % SiOₓ (x is equal to or less than 2) coated Pt/Siralox catalyst indicated that the size distribution of Pt nanoparticles remained the same at 1 to 6 nm. The thickness of SiOₓ (x is equal to or less than 2) shell was determined to be between 0.5 to 5 nm. The BET surface area of thus prepared 20 wt % SiOₓ (x is equal to or less than 2) coated Pt/Siralox catalyst was measured to be 75 m²/g.

### Example 15

### Coating of the Entire Support and Active Metal with SiOₓ (x is Equal to or Less than 2)

The experiment was carried out in a manner analogous to example 12, the only difference being that in the synthesis of SiOₓ (x is equal to or less than 2) shell, water glass solution was added in such an amount that a SiO₂ loading of 30 wt % (based on the total weight of support, active metal and shell) was obtained. HRTEM characterization of the 30 wt % SiOₓ (x is equal to or less than 2) coated Pt/Siralox catalyst indicated that the size distribution of Pt nanoparticles remained the same at 1 to 6 nm. The thickness of SiOₓ (x is equal to or less than 2) shell was determined to be between 0.5 to 10 nm. The BET surface area of thus prepared 20 wt % SiOₓ (x is equal to or less than 2) coated Pt/Siralox catalyst was measured to be 63 m²/g.

### Reference Samples

To interpret the catalytic activity (L/0 temperatures on fresh and aged catalysts), reference samples having the same element distribution (noble metal loading, amount of Si and support material the same as in the examples above) but without a shell based on SiOₓ (x is equal to or less than 2) were produced. The general method of producing the comparative catalysts is described below; the amount of noble metal was matched to the abovementioned examples.

### Production of Comparative Catalysts 1 and 2:

A relatively large amount of SBa-150 was predried at 100° C. for 1 hour in a convection drying oven. 5 g of the support which had been predried in this way were weighed into a 100 ml 1-neck round-bottom flask and attached to a rotary evaporator and the powder in the flask was heated at 90 rpm for 10 min at an oil bath temperature of 80° C. As impregnation solution, tetrammineplatinum acetate solution (TAAC for short, Pt(NH₃)₄(CH₃CO₂)₂, CAS=127733-97-5, Umicore) was added in such an amount that the necessary noble metal loading (analogous to the examples) was achieved. The system is diluted with water to 200% of the water uptake. The impregnation solution was taken up in the rotary evaporator over a period of 10 minutes at 800 mbar, 90 rpm and an oil bath temperature of 80° C. and the powder was thus impregnated. The vacuum was reduced to 100 mbar over a period of 60 minutes and the solid was dried for 30 minutes at 100 mbar, an oil bath temperature of 80° C. and 90 rpm.

The dried and impregnated material was pressed through a 1 mm sieve and introduced into a fused silica reactor for the subsequent calcination. The fused silica reactor has a length of 900 mm and an internal diameter of 13 mm. A fused silica frit, pore size P2, is fused in in the middle and the powder rests on this. This filled fused silica reactor is installed in a tube furnace and calcined under the following conditions: 1st stage: under a gas flow of 75 ml/min of air from the top downward, at 1 K/min to 265° C. and hold for 1 hour; 2nd stage: under a gas flow of 75 ml/min of nitrogen from the top downward, at 4 K/min to 500° C. and hold for 1 hour and cool under nitrogen.

After calcination, the sample was tableted on a tabletting press XP1 from Korsch (no lubricant, 13 mm punch, fill height 8 mm, distance into the die 6 mm, pressing force 20 kN). The tablets were cracked by means of a mortar and pestle and pressed through a 0.5 mm sieve. The target fraction of 250-500 μm was sieved off manually over a period of 10 seconds.

### Production of Comparative Catalyst 3:

17.5383 g of tetrammineplatinum acetate solution (TAAC for short, Pt(NH₃)₄(CH₃CO₂)₂, CAS=127733-97-5, Umicore) were diluted with 80 g of diethylene glycol (99% from Sigma-Aldrich Lot No.: S46287-078 (DEG)). In parallel, 100 g of support material (SBa-150 from Sasol) were weighed into 140 g of DEG and the support was briefly dispersed by means of a propeller stirrer (5 min, 400 rpm) and 5% of PVP (polyvinylpyrrolidone K 30 (Fluka: CAS:9003-99-8)), based on the metal, was added. The mixture of support and stabilizer was heated at 80° C. for 10 minutes to dissolve the PVO completely. The noble metal solution was subsequently introduced by means of a syringe into the support dispersion at a temperature of 80° C. and the system was maintained at this temperature for 2 hours while stirring vigorously (400 rpm). The solvent was subsequently decanted off, the moist powder was freed of residual glycol at 120° C. in a vacuum drying oven for 12 hours and the powder was subsequently calcined (heating rate: 0.5 K/min to 300° C., 2 K/min to 540° C., maintained at this temperature for 1 hour; nitrogen atmosphere).

### Production of Comparative Catalyst 4:

The synthesis of comparative catalyst 4 is analogous to example 5, the only difference is that after impregnation of Pt and calcination, no SiOₓ (x is equal to or less than 2) shell was synthesized.

### Production of Comparative Catalyst 5:

The synthesis of comparative catalyst 5 is analogous to example 9, the only difference is that after impregnation of Pt and calcination, no SiOₓ (x is equal to or less than 2) shell was synthesized.

### Production of Comparative Catalyst 6:

The synthesis of comparative catalyst 6 is analogous to example 12, the only difference is that after impregnation of Pt and calcination, no SiOₓ (x is equal to or less than 2) shell was synthesized.

### Catalyst Shaping for Catalytic Tests:

Calcined Pt-containing powders prepared as described in examples were mixed with milled alumina slurry (TM100/150, d₉₀<15 μm) used as binder material. The ratio of Pt-containing powder-to-alumina from the binder slurry was 70 wt % to 30 wt %. The blend was dried under stirring at 100° C. and calcined at 300° C. in air for 15 min. The resulting cake was crushed and sieved to target fraction.

Aging was carried out in a muffle furnace (Hereaus M110). The catalyst sample was heated at 5 K/min to 750° C. and maintained at this temperature for 20 hours, with 5.4 l/min of air being introduced. As soon as the temperature in the furnace had risen above 100° C., 0.43 g/min of water was introduced into the furnace by means of an HPLC pump so that a 10% water vapor atmosphere was obtained. The sample was then cooled under the same gas atmosphere, with the introduction of water being stopped below 150° C.

The catalyst testing was in each case carried out as follows:

### Activity Tests

Activity measurements on the catalyst were carried out in a fully automatic catalysis plant having 16 stainless steel fixed-bed reactors operated in parallel using simulated lean-burn exhaust gas. The catalysts were tested in continuous operation using an excess of oxygen under the following conditions:

Temperature range: 120-300° C.

Exhaust gas composition: 1500 ppm of CO, 100 ppm of NO, 450 ppm of C₁ HC (C₁₀H₂₂/C₇H₈/C₃H₆/CH₄=4/2/2/1), 13% of O₂, 10% of CO₂, 5% of H₂O

Gas throughput: 80 l/h per catalyst

Mass of catalyst: were adjusted to keep constant Pt amount (2 mg) in each reactor.

For the evaluation of the catalysts, the T₅₀ values (temperature at which 50% conversion is achieved; referred to as light off temperature) were employed for the CO and HC oxidation and the yield of NO₂ from NO at 250° C. (Y—NO₂) was employed for evaluation of the oxidation activity.

The hydrothermal aging was carried out at a temperature of 750° C. (for precise description, see above).

The T₅₀ values and Y—NO₂ for the catalysts in the fresh state and after hydrothermal aging are summarized as follows:

Catalysis tests for examples 1 and 2, where only the noble metals are surrounded by a protective SiOₓ (x is equal to or less than 2) layer. It can be seen that compared with the corresponding comparative catalysts, example 1 shows lower T₅₀CO and T₅₀HC not only in the fresh state but also after hydrothermal aging. This confirms the benefit of the current invention.

| | | | | | Y—NO₂ at | |
|---|---|---|---|---|---|---|
| | T₅₀-CO [° C.] | | T₅₀-HC [° C.] | | 250° C. [%] | |
| | fresh | aged | fresh | Aged | fresh | aged |
| Example 1 | 171 | 199 | 189 | 205 | 29 | 6 |
| Comparative | 228 | 238 | 225 | 232 | 27 | 0 |
| catalyst 1 | | | | | | |
| Example 2 | 181 | 221 | 198 | 238 | 17 | 3 |
| Comparative | 173 | 226 | 186 | 219 | 40 | 9 |
| catalyst 2 | | | | | | |

Catalyst tests of example 4, where the entire support (and thus also the noble metals present thereon) is surrounded by a protective SiOₓ (x is equal to or less than 2) shell. The SiOₓ (x is equal to or less than 2) coated sample showed similar fresh activity compared to the comparative catalyst. After aging, the SiOₓ (x is equal to or less than 2) coated sample showed obviously higher activities (as indicated by the much lower T₅₀CO and T₅₀HC). This confirms that the sintering of active metal could be effectively prevented using the method illustrated in the current invention.

| | | | | | Y—NO₂ at | |
|---|---|---|---|---|---|---|
| | T₅₀-CO [° C.] | | T₅₀-HC [° C.] | | 250° C. [%] | |
| | fresh | aged | fresh | aged | fresh | aged |
| Example 4 | 159 | 202 | 177 | 209 | 51 | 23 |
| Comparative | 156 | 225 | 173 | 226 | 64 | 14 |
| catalyst 3 | | | | | | |

Catalyst tests of example 5 to example 8, where the entire support (and thus also the noble metals present thereon) is surrounded by a protective SiOₓ (x is equal to or less than 2) shell. When the catalysts were coated with up to 30 wt % of SiOₓ (x is equal to or less than 2), the coated samples showed same fresh activity compared to the comparative catalyst. After aging, the SiOₓ (x is equal to or less than 2) coated sample showed obviously higher activities (as indicated by the much lower T₅₀CO and T₅₀HC). This confirms that the sintering of active metal could be effectively prevented using the method illustrated in the current invention. When the catalyst was coated with 60 wt % of SiOₓ (x is equal to or less than 2), the coated catalyst showed a lower activities both in the fresh state and after aging compared to catalysts with less SiOₓ (x is equal to or less than 2). HRTEM characterization of the comparative catalyst 4 after hydrothermal aging showed that the size of Pt nanoparticles increased from the original 3 to 8 nm to up to several hundred nanometers, indicating the severe sintering of Pt for the uncoated sample. On the contrary, HRTEM characterization of all SiOₓ (x is equal to or less than 2) coated samples (example 5 to 8) showed that the size of Pt nanoparticles remained less than 15 nm. This again confirms that the sintering of active metal could be effectively prevented using the method illustrated in the current invention.

| | | | | | Y—NO₂ at | |
|---|---|---|---|---|---|---|
| | T₅₀-CO [° C.] | | T₅₀-HC [° C.] | | 250° C. [%] | |
| | fresh | aged | fresh | Aged | fresh | aged |
| Example 5 | 186 | 197 | 187 | 205 | * | * |
| Example 6 | 186 | 191 | 187 | 206 | * | * |
| Example 7 | 184 | 187 | 191 | 202 | 67 | 15 |
| Example 8 | >250 | >250 | * | * | * | * |
| Comparative | 182 | 226 | 187 | 223 | 76 | 28 |
| catalyst 4 | | | | | | |

* not tested

Catalyst tests of example 9 to example 11, where the entire support (and thus also the noble metals present thereon) is surrounded by a protective SiOₓ (x is equal to or less than 2) shell. The SiOₓ (x is equal to or less than 2) coated sample showed same fresh activity compared to the comparative catalyst. After aging, the SiOₓ (x is equal to or less than 2) coated sample showed obviously higher activities (as indicated by the much lower T₅₀CO and T₅₀HC). This confirms that the sintering of active metal could be effectively prevented using the method illustrated in the current invention. HRTEM characterization of the comparative catalyst 5 after hydrothermal aging showed that the size of Pt nanoparticles increased from the original 1 to 6 nm to up to several hundred nanometers, indicating the severe sintering of Pt for the uncoated sample. On the contrary, HRTEM characterization of all SiOₓ (x is equal to or less than 2) coated samples (example 9 to 11) showed that the size of Pt nanoparticles only slightly increased from the original 1 to 6 nm to 3 to 12 nm. This again confirms that the sintering of active metal could be effectively prevented using the method illustrated in the current invention.

| | | | | | Y—NO₂ at | |
|---|---|---|---|---|---|---|
| | T₅₀-CO [° C.] | | T₅₀-HC [° C.] | | 250° C. [%] | |
| | fresh | aged | fresh | Aged | fresh | aged |
| Example 9 | 155 | 194 | 172 | 204 | 77 | 40 |
| Example 10 | 158 | 191 | 174 | 200 | 59 | 47 |
| Example 11 | 161 | 200 | 178 | 207 | 71 | 40 |
| Comparative | 158 | 202 | 171 | 210 | 82 | 58 |
| catalyst 5 | | | | | | |

Catalyst tests of example 12 to example 15, where the entire support (and thus also the noble metals present thereon) is surrounded by a protective SiOₓ (x is equal to or less than 2) shell. The SiOₓ (x is equal to or less than 2) coated sample showed similar fresh activity compared to the comparative catalyst (except for example 15). After aging, the SiOₓ (x is equal to or less than 2) coated sample showed obviously higher activities (as indicated by the much lower T₅₀CO and T₅₀HC). This confirms that the sintering of active metal could be effectively prevented using the method illustrated in the current invention. HRTEM characterization of the comparative catalyst 6 after hydrothermal aging showed that the size of Pt nanoparticles increased from the original 1 to 6 nm to up to several hundred nanometers, indicating the severe sintering of Pt for the uncoated sample. On the contrary, HRTEM characterization of all SiOₓ (x is equal to or less than 2) coated samples (example 12 to 15) showed that the size of Pt nanoparticles only slightly increased from the original 1 to 6 nm to 3 to 10 nm. This again confirms that the sintering of active metal could be effectively prevented using the method illustrated in the current invention.

| | | | | | Y—NO₂ at | |
|---|---|---|---|---|---|---|
| | T₅₀-CO [° C.] | | T₅₀-HC [° C.] | | 250° C. [%] | |
| | fresh | aged | fresh | Aged | fresh | aged |
| Example 12 | 148 | 187 | 174 | 200 | 52 | 50 |
| Example 13 | 153 | 187 | 174 | 205 | 56 | 39 |
| Example 14 | 154 | 201 | 172 | 216 | 54 | 12 |
| Example 15 | 170 | 205 | 209 | 231 | 4 | 6 |
| Comparative | 155 | 200 | 174 | 209 | 55 | 41 |
| catalyst 6 | | | | | | |

1. A catalyst, comprising:
a support;
metal particles; and
a shell,
wherein the shell is arranged between the metal particles and the shell comprises silicon oxide.

2. The catalyst according to claim 1,
wherein the shell comprises from 0.1 to 10% by weight, based on a total weight of the shell, of Zr, Ce, Ti, Al, Nb, La, In, Zn, Sn, Mg, Ca, Li, Na, K, or any mixtures thereof.

3. The catalyst according to claim 1, wherein the shell has a layer thickness of from 0.5 nm to 2000 nm.

4. The catalyst according to claim 1, wherein the shell has pores having a diameter of from 0.5 nm to 40 nm.

5. The catalyst according to claim 1, wherein the shell envelopes the metal particles.

6. The catalyst according to claim 1, comprising from 0.1 to 35% by weight of SiO₂, based on a total weight of the support, the metal particles, and the shell.

7. The catalyst according to claim 1, wherein the metal particles are arranged on the support and are in contact with the support, and the shell envelopes the support with the metal particles.

8. The catalyst according to claim 1, wherein the metal particles comprise gold, silver, platinum, rhodium, palladium, copper, nickel, iron, ruthenium, osmium, chromium, vanadium, manganese, molybdenum, cobalt, zinc and mixtures and/or alloys thereof.

9. The catalyst according to claim 1, wherein the metal particles have a diameter in the range of from 0.1 nm to 200 nm.

10. The catalyst according to claim 1, wherein the catalyst comprises from 0.1 to 20% by weight of the metal particles, based on the total weight of the support, the metal particles, and the shell.

11. The catalyst according to claim 1, wherein the support comprises at least one oxide selected from the group consisting of Al, Ce, Zr, Ti, and Si.

12. The catalyst according to claim 1, wherein the support has a diameter of from 0.5 to 5000 nm.

13. The catalyst according to claim 1, wherein the support has a BET surface area measured in accordance with DIN ISO 9277 of greater than 5 m²/g.

14. A process for producing a catalyst comprising
a support, metal particles, and a shell based-en comprising silicon oxide, the process comprising:
producing the metal particles by the process comprising reducing an optionally stabilized metal salt solution;
producing the shell which encloses the metal particles by the process comprising reacting a water-soluble, hydrolyzable Si compound in presence of the metal particles;
introducing the support into dispersion comprising the metal particles and the shell; and
removing solvent from dispersion comprising the support, the metal particles, and the shell.

16. A process for producing a catalyst comprising a support, metal particles and a shell comprising silicon oxide, the process comprising:
dispersing the support comprising the metal particles, thereby obtaining a dispersion;
adding a water-soluble, hydrolyzable Si compound to the dispersion; and
removing solvent from the catalyst comprising the support, the metal particles, and the shell.
